(19) United States
(12) Patent Application Publication
(10) Pub. No.: US 2020/0384783 A1
(43) Pub. Date: Dec. 10, 2020

(54) Holdown Process and System for Platen

(71) Applicant: Impossible Objects, Inc., Northbrook, IL (US)

(72) Inventors: Robert Swartz, Highland Park, IL (US); Eugene Gore, Des Plaines, IL (US); Drew Marchner, Northbrook, IL (US)

(73) Assignee: Impossible Objects, Inc, Northbrook, IL (US)

(21) Appl. No.: 16/876,035

(22) Filed: May 16, 2020

Related U.S. Application Data
(60) Provisional application No. 62/849,021, filed on May 16, 2019.

(51) Int. Cl. B41J 11/06; B25B 5/04

(52) U.S. Cl. CPC B41J 11/06; B25B 5/04

(57) ABSTRACT

A method/system of mechanical holdowns allows a substrate sheet in a CBAM (composite-based additive manufacturing technology) process to lie flat during printing. The invention includes a process of mechanically clamping sheets to be printed by a print head to a flat platen using a set of barrel cam driven clamping fingers. The finger supports are attached to the platen and the fingers can be raised and lowered with respect to the platen. Each finger can rotate while swinging downward toward a sheet at the edge of the platen. To clamp the sheet, the fingers are rotated to the perpendicular position and swung lower down to pinch the sheet to the platen. The process can include additional steps that release some, but not all, of the fingers to allow the sheet to relax before re-clamping them.

The following patents and applications are hereby incorporated by reference in their entireties: U.S. Pat. Nos. 9,776,376, 9,833,949, 10,046,552, 10,252,487, 10,377,080, 10,377,106, 10,384,437 and 10,597,249 and U.S. patent application Ser. Nos. 16/195,362, 16/544,906, 15/923,335, 15/922,158 and 16/711,313.

### BACKGROUND

### Field of the Invention

The present invention relates to an improvement in the platen in a 3D material printing machine and process, and more particularly to improved holdowns that hold a flat substrate sheet down during processing.

### Description of the Problem Solved

In the assignee's prior applications and patents (as incorporated by reference above), mechanical and vacuum holdowns were used to hold the sheet in place while it was printed. Vacuum holdowns as described in the earlier disclosure require a vacuum which is expensive, produces significant noise, and uses substantial power. It would be advantageous to have a mechanical holdown that reduces the power consumption and the noise of the machine. In addition, the vacuum may sometimes cause a droplet at the inkjet head to mist, thus causing misprinting and reducing the printable area of the sheet. It would be advantageous to eliminate these problems.

### SUMMARY OF THE INVENTION

The present invention is a new method and system of mechanical holdowns which allow a substrate sheet in a CBAM (composite-based additive manufacturing technology) process to lie flat during printing. The invention includes the process of mechanically clamping sheets to be printed by a print head to a flat platen using a set of barrel cam driven clamping fingers. The fingers are attached to the platen and can be raised and lowered with respect to the platen. In addition, while being raised or lowered, each finger can rotate at least ninety degrees to either face perpendicularly into the edge of the platen or to be parallel to the edge of the platen. To clamp the sheet, the fingers are rotated to the perpendicular position and lowered down to pinch the sheet to the platen. The process can include additional steps that release some, but not all, of the fingers to allow the sheet to relax before re-clamping them.

### DESCRIPTION OF THE FIGURES

Attention is directed to the following figures that illustrate features of the present invention.

FIG. 1A shows a platen with four finger clamps. In a first step, all four clamps are in the unclamped configuration.

FIG. 1B shows a second step with the substrate sheet loaded and the clamps rotated and driven downward to the clamped configuration.

FIG. 2A shows a next step with two of the clamps in the unclamped configuration and two clamps in the clamped configuration.

FIG. 2B shows a possible next step with the opposite two clamps relaxed in the unclamped configuration.

FIG. 3 shows a next step with all four clamps in the clamped configuration and a pattern printed on the substrate sheet.

FIG. 4 shows a next step with all four clamps in the unclamped configuration and the sheet moved to the next station.

FIG. 5A shows a top and side views of a clamp in the clamped configuration.

FIG. 5B shows a top and side views of a clamp in the unclamped configuration.

FIG. 5C shows a profile view of a clamp in the clamped configuration.

Several figures have been presented to aid in understanding the present invention. The scope of the present invention is not limited to what is shown in the figures.

### DESCRIPTION OF THE PREFERRED EMBODIMENTS

The foregoing summary, as well as the following detailed description of the preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown.

The invention includes the process of mechanically clamping sheets to be printed by a print head to a flat platen using a set of barrel cam driven clamping fingers. The fingers are attached to the platen and can be raised and lowered with respect to the platen. In addition during such raising or lowering, each finger can rotate at least ninety degrees to either face perpendicularly into the edge of the platen or to be parallel to the edge of the platen. To clamp the sheet, the fingers are rotated to the perpendicular position and lowered down to pinch the sheet to the platen. The process can include additional steps that release some, but not all, of the fingers to allow the sheet to relax.

### Process Description

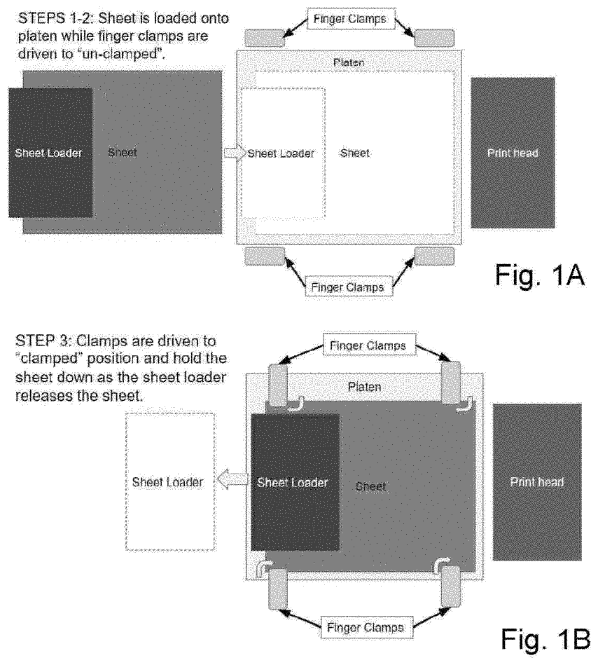

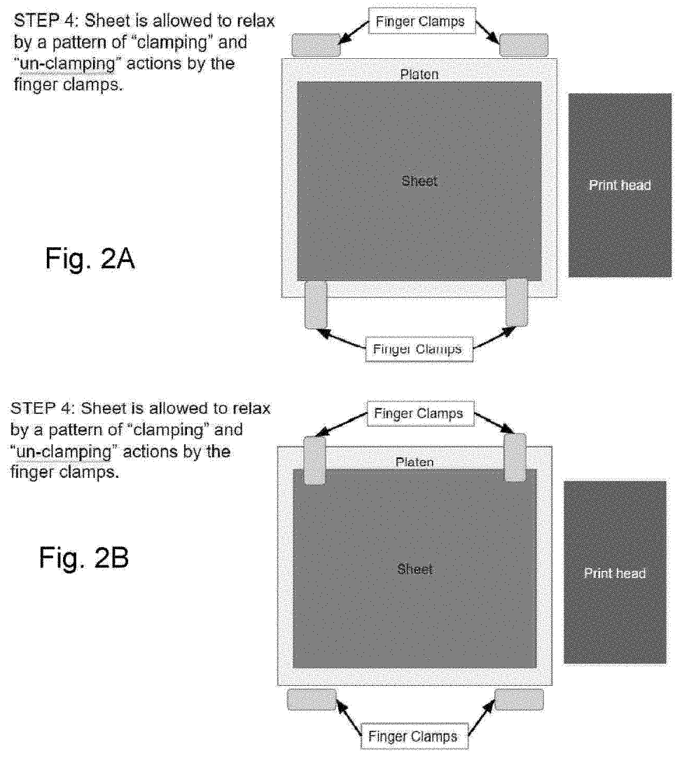

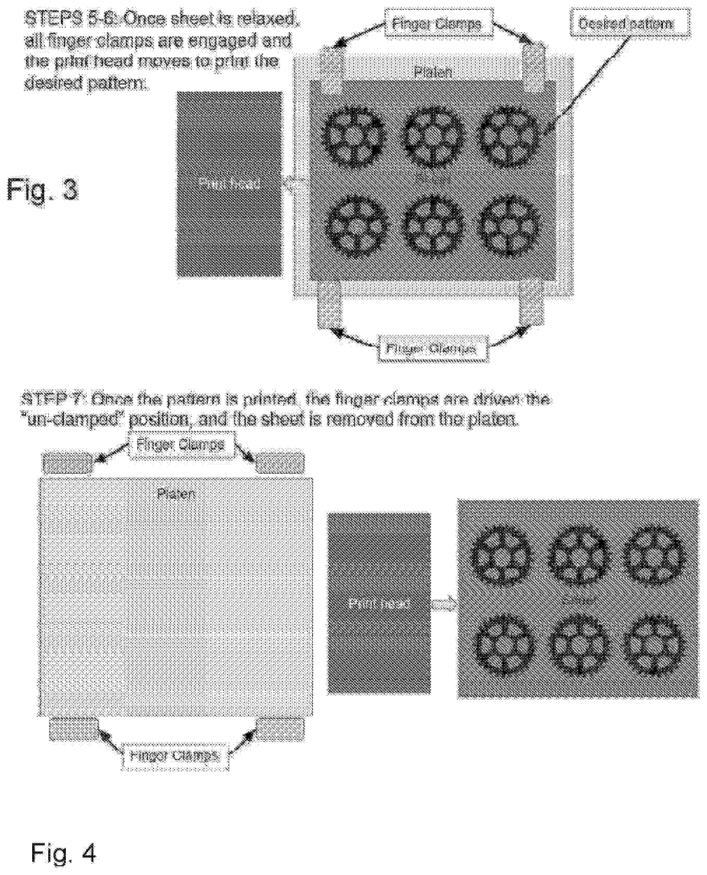

1. Before a sheet is deposited onto the printing surface (platen), the clamping fingers are raised to the unclamped configuration (FIG. 1A) leaving the platen free to receive a sheet with the fingers of clamps out of the way of the sheet.
2. A sheet of the desired substrate (carbon fiber, fiberglass, etc.) is deposited onto the platen (FIG. 1B). This can be done using any of the variety of methods described in the CBAM patents and applications incorporated herein by reference.
3. During the placement of the sheet, the clamping fingers are turned inward and lowered to the clamped configuration (FIG. 1B), which secures the sheet to the platen by pinching it to the platen.
4. Once the sheet is secured to the platen by the clamping fingers, the clamping fingers can briefly disengage and rise in a pre-ordered fashion (FIGS. 2A-2B) so as to allow the sheet to relax and release any warp, or bow that may have been imparted to the sheet during the sheet placement onto the platen. At no time during this operation is the sheet not clamped by at least two clamping fingers. The flattening and relaxing step thus does not disrupt the overall sheet position on the platen.
5. Once the sheet has been allowed to relax to a flat state on the platen, all clamping fingers are engaged to the clamped configuration (FIG. 3).
6. A print head prints onto the clamped sheet (FIG. 3).
7. Once the print head has completed the print pattern, the clamping fingers are raised and turned once again to the unclamped configuration, and the sheet is removed from the platen (FIG. 4). This can be done using any of the variety of methods described in the CBAM patents and applications incorporated herein by reference.
8. The process repeats for as many sheets as need printing.

The sheets so-printed are then subject to the rest of the CBAM process that follows after printed sheets get collected and layered. This can be done using any of the variety of methods described in the CBAM patents and applications incorporated herein by reference. The end result is a composite-based 3D-printed part.

### Finger Clamp Description

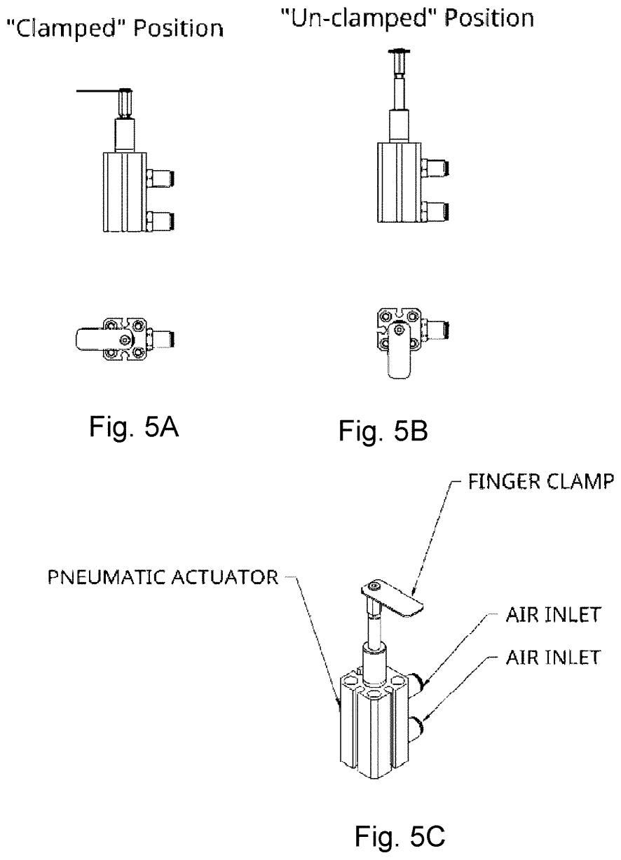

Turning to FIGS. 5A-5C, it can be seen that a finger clamp can include or be made from a variety of mechanisms and actuation forces to allow for gentle clamping of sheets. A particular embodiment includes a pneumatically driven barrel cam actuator with a gripping finger attached to the end effector of the pneumatic SMC MKB12-10RZ-A93L cylinder, rotary clamp manufactured by SMC Corporation Tokyo, Japan. Other products specified in the MK series of rotary clamp cylinders may also be appropriate for specific applications, according to the needs of and variations sought by the system designer, as would be appreciated by persons of ordinary skill in the art once informed of the teachings herein. The barrel cam allows for rotation during the vertical translation of the finger. This rotation is important as it allows for the gripping finger to be moved out of the way during operations in which the sheet needs to be moved from the platen, or allowed to relax.

Several descriptions and illustrations have been presented to aid in understanding the present invention. One with skill in the art will realize that numerous changes and variations may be made without departing from the spirit of the invention. Each of these changes and variations is within the scope of the present invention.

1. A process of holding a flat sheet on a platen having at least two clamping fingers comprising:
(a) raising the clamping fingers to an unclamped configuration;
(b) depositing a substrate sheet onto the platen;
(c) lowering the clamping fingers to a clamped configuration holding down the substrate sheet;
(d) raising at least one clamping finger to the unclamped configuration allowing the substrate sheet to relax with at least one other clamping finger remaining in the clamped configuration;
(e) lowering the clamping finger to the clamped configuration;
(f) printing a pattern onto the substrate sheet;
(g) raising clamping fingers to the unclamped configuration;
(h) removing the substrate sheet from the platen.

2. The process of claim 1 further comprising repeating steps (a)-(h) for a plurality of substrate sheets.

3. The process of claim 1 further comprising within steps (c), (d) and (e) rotating the respective clamping finger at the same time as it is raised or lowered.

4. The process of claim 3 wherein the rotation between a raised and a lowered position is substantially 90 degrees.

5. The process of claim 1 wherein step (e) also includes (d)(2) raising a different at least one clamping finger to the unclamped configuration after lowering the at least one clamping finger previously raised in step (d) to a new clamping position, such that different fingers alternately remain in the clamped configuration.

6. The process of claim 1 wherein each clamping finger includes a pneumatically driven barrel cam actuator with a gripping finger attached.

7. The process of claim 6 wherein each clamping finger also includes a pneumatic cylinder and rotary clamp.

8. The process of claim 7 wherein the pneumatic cylinder and rotary cam is a SMC MK series rotary clamp cylinder manufactured by SMC Corporation Tokyo, Japan.

9. A print platen comprising:
a flat substantially platen bed with a plurality of edge regions;
a plurality of finger clamps supported at the edge regions of the platen bed; wherein, each finger clamp is constructed to move vertically with respect to the platen bed and to rotate horizontally with respect to the platen bed; the finger clamps having an unclamped configuration when rotated away from the platen bed and raised above the platen bed, and a clamped configuration when rotated over the platen bed and lowered against the platen bed.

10. The print platen of claim 9 wherein the platen bed is substantially rectangular, and there are two edge regions with at least one finger clamp in each edge region.

11. The print platen of claim 10 wherein there are four finger clamps, two at each edge region.
